(19) United States
(12) Patent Application Publication
(10) Pub. No.: US 2024/0068624 A1
(43) Pub. Date: Feb. 29, 2024

(54) GAS CYLINDER BUNDLE

(71) Applicant: TOYOTA JIDOSHA KABUSHIKI KAISHA, Toyota-shi (JP)

(72) Inventor: Koji KATANO, Toyota-shi (JP)

(73) Assignee: TOYOTA JIDOSHA KABUSHIKI KAISHA, Toyota-shi (JP)

(21) Appl. No.: 18/329,666

(22) Filed: Jun. 6, 2023

(30) Foreign Application Priority Data
Aug. 26, 2022 (JP) 2022-135102

(51) Int. Cl. F17C 13/08

(52) U.S. Cl. CPC F17C 13/084; F17C 2201/0109; F17C 2203/0604; F17C 2203/0673; F17C 2205/0107; F17C 2205/013; F17C 2205/0169; F17C 2205/0188; F17C 2205/0192; F17C 2205/0323; F17C 2205/0338; F17C 2221/012

(57) ABSTRACT

A gas cylinder bundle includes a gas cylinder bundle frame and a high-pressure tank arranged on the gas cylinder bundle frame. The gas cylinder bundle frame is equipped with a plurality of levels of shelf portions in an up-down direction on which the high-pressure tank is arranged. The high-pressure tank is arranged such that an axial direction of the high-pressure tank arranged on a shelf portion of a next level above a shelf portion of one level faces a direction rotated by 90° with respect to an axial direction of the high-pressure tank arranged on the shelf portion of the one level.

### CROSS-REFERENCE TO RELATED APPLICATION

This application claims priority to Japanese Patent Application No. 2022-135102 filed on Aug. 26, 2022, incorporated herein by reference in its entirety.

### BACKGROUND

### 1. Technical Field

The present disclosure relates to a gas cylinder bundle.

### 2. Description of Related Art

Japanese Unexamined Patent Application Publication No. 2020-020430 (JP 2020-020430 A) and Japanese Unexamined Patent Application Publication No. 2005-308185 (JP 2005-308185 A) disclose a structure of a gas cylinder bundle in which a plurality of high-pressure gas cylinders is stacked and fixed in a plurality of levels in an up-down direction to supply gas.

### SUMMARY

When tanks are stacked in a plurality of levels, a load is applied to a gas cylinder bundle frame. Therefore, it is necessary to increase the strength of the gas cylinder bundle frame (frame strength), resulting in an increase in the weight of the entire gas cylinder bundle.

The present disclosure has been made in view of these circumstances, and an object of the present disclosure is to provide a gas cylinder bundle in which the strength is efficiently increased and the weight is reduced as necessary.

The present application relates to a gas cylinder bundle including a gas cylinder bundle frame and a high-pressure tank arranged on the gas cylinder bundle frame, and discloses the gas cylinder bundle in which the gas cylinder bundle frame is equipped with a plurality of levels of shelf portions in an up-down direction on which the high-pressure tank is arranged, and the high-pressure tank is arranged such that an axial direction of the high-pressure tank arranged on a shelf portion of a next level above a shelf portion of one level faces a direction rotated by 90° with respect to an axial direction of the high-pressure tank arranged on the shelf portion of the one level.

The number of a plurality of the levels may be a multiple of four.

When the number of the levels is five or more, the high-pressure tank may be arranged such that the direction rotated by 90° is opposite for each level in which the number of the shelf portions is a multiple of four.

A plurality of the high-pressure tanks may be arranged on the shelf portion of the one level, and a direction in which valves are arranged in adjacent high-pressure tanks may be opposite.

A regulator may be arranged in an uppermost level among the levels.

A suspension member for hooking a suspension wire may be arranged on an upper portion, and an elastic body may be arranged in a portion of the suspension member for hooking the wire.

The high-pressure tank may be fixed to the gas cylinder bundle frame by a band, and the band may be connected at adjacent upper and lower levels.

One end of the band may be fixed to the gas cylinder bundle frame via an elastic body, and for connection of the band at the adjacent upper and lower levels, a side where the elastic body is arranged may be fixed.

According to the present disclosure, the strength of the gas cylinder bundle can be efficiently increased, and the weight of the gas cylinder bundle can be reduced as required.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram schematically showing an appearance of a gas cylinder bundle 10;

FIG. 1B is a diagram schematically showing an appearance of the gas cylinder bundle 10;

FIG. 2 is a diagram schematically showing an appearance of a high-pressure tank 20;

FIG. 3 is a diagram illustrating that the high-pressure tank 20 is fixed to a gas cylinder bundle frame 11;

FIG. 4 is a diagram illustrating arrangement of the high-pressure tanks 20;

FIG. 5A is a diagram illustrating a suspension member 30;

FIG. 5B is a diagram illustrating the suspension member 30; and

FIG. 6 is a diagram illustrating connection of a band 25.

### DETAILED DESCRIPTION OF EMBODIMENTS

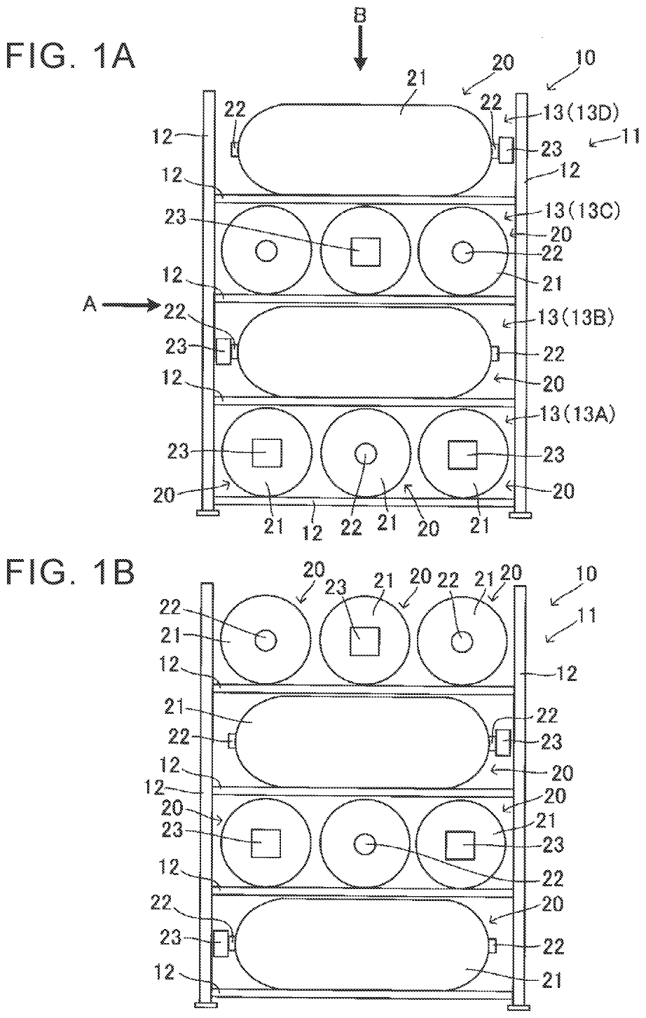

FIGS. 1A and 1B each illustrate a configuration of a gas cylinder bundle 10 according to the present disclosure. FIG. 1A is a view of the gas cylinder bundle 10 viewed from one side, with the top and the bottom of the drawing sheet being a vertical direction, the bottom of the drawing sheet being a bottom, and the top of the drawing sheet being a top. FIG. 1B is a view of the gas cylinder bundle 10 viewed from a direction of arrow A in FIG. 1A. As can be seen from FIGS. 1A and 1B, the gas cylinder bundle 10 includes a gas cylinder bundle frame 11 and a plurality of high-pressure tanks 20 arranged on the gas cylinder bundle frame 11.

Structure of High-Pressure Tank

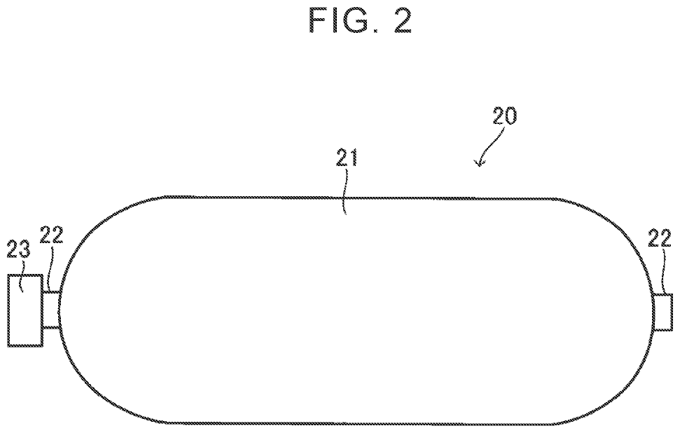

FIG. 2 schematically shows an appearance of the high-pressure tank 20 according to one form. The form of the high-pressure tank is not particularly limited, and a known form can be used. However, the high-pressure tank 20 according to the form includes a tank body 21, necks 22, and a valve 23.

Tank Body 21

The tank body 21 is a portion that forms a region for storing a target fluid (storage medium such as hydrogen), and has a cylindrical shape with a cavity. The storage medium is stored inside this cavity. The tank body 21 has a laminated structure of a liner, a reinforcing layer, and a protective layer from the inside thereof.

The liner is a hollow member that constitutes the inner wall of the tank body 21 and partitions the internal space. The liner may be made of a material that can hold the storage medium in the internal space without leaking, and a known material can be used. For example, the liner is made of nylon resin, polyethylene-based resin, or metal such as stainless steel and aluminum. Although the thickness of the liner is not particularly limited, it is preferably 0.5 mm to 1.0 mm.

Among them, the liner is preferably made of resin from the viewpoint of being able to exhibit the effects of the present disclosure more remarkably. When the liner is made of resin, the weight of the tank body 21 can be reduced. However, since the valve 23 is made of metal and heavy, the ratio of the weight of the valve 23 in the high-pressure tank 20 increases. Here, since the valve 23 is provided only at one end of the tank body 21 in an axial direction as will be described later, the position of the center of gravity of the high-pressure tank 20 deviates from the center of gravity of the tank body 21. As the weight of the tank body 21 is reduced, the weight of the valve 23 has a greater influence, which increases the amount of deviation of the center of gravity. As a result, an influence on the vibration and deformation to the gas cylinder bundle 10 equipped with the high-pressure tanks 20 is increased. The gas cylinder bundle 10 according to the present disclosure is effective even when such a relatively lightweight high-pressure tank 20 is applied, and the effect is remarkable for a high-pressure tank using a metal liner.

The reinforcing layer has a plurality of layers of fibers laminated and resin impregnated into the fibers and cured. The layers of the fibers are constructed by winding a number of layers of fiber bundles up to a predetermined thickness on the outer surface of the liner. The thickness of the reinforcing layer is determined by the required strength and is not particularly limited, but is about 10 mm to 30 mm.

Carbon fibers are used as the fiber bundles for the reinforcing layer, and the fiber bundles are in a strip shape in which the carbon fibers form a bundle with a predetermined cross-sectional shape (for example, a rectangular cross section). Although not specifically limited, the cross-sectional shape may be a rectangle with a width of about 6 mm to 10 mm and a thickness of about 0.1 mm to 0.15 mm. Although the amount of carbon fibers included in the fiber bundle is not particularly limited, for example, about 24,000 carbon fibers are included.

The resin impregnated into the fibers and cured in the reinforcing layer is not particularly limited as long as it can increase the strength of the fibers. Examples thereof can include thermosetting resins cured by heat, such as epoxy resins containing amine-based or anhydride-based curing accelerators and rubber-based reinforcing agents, unsaturated polyester resins, and the like. In addition, a resin composition having an epoxy resin as a main agent and being cured by mixing the main agent with a curing agent can also be included. According to this, the resin composition, which is the mixture, reaches and permeates the fiber layer between the time when the main agent and the curing agent are mixed and the time when the mixture is cured, so that the mixture is automatically cured. Due to the reinforcing layer as described above, the weight of the high-pressure tank 20 can be reduced while the strength thereof is maintained.

The protective layer is a layer arranged on the outer periphery of the reinforcing layer as required, and when the protective layer is provided, for example, glass fiber is wound around the protective layer, and the glass fiber wound around the protective layer is impregnated with resin. The impregnated resin can be considered similar to the reinforcing layer. Thereby, impact resistance can be imparted to the high-pressure tank 20. Although the thickness of the protective layer is not particularly limited, it can be about 1.0 mm to 2.0 mm.

Neck

The neck 22 is a member attached to each of the two open ends of the liner having a cylindrical shape, and one of the necks 22 functions as an opening that communicates inside and outside of the high-pressure tank 20, and functions as an attaching portion for attaching a pipe and a valve to the high-pressure tank 20.

Valve

The valve 23 is arranged on one of the two necks 22, and switches between permitting and restricting the storage medium in and out of the tank body 21. The specific form of the valve 23 is not particularly limited, and a known form can be used.

Gas Cylinder Bundle Frame

The gas cylinder bundle frame 11 is constructed by combining a plurality of frame members 12 vertically and horizontally three dimensionally to form a shelf portion 13 extending over a plurality of levels, and constructed such that the high-pressure tanks 20 can be arranged and held on each level. A known form of the structure of the gas cylinder bundle frame constructed by combining the frame members 12 can also be used. However, as will be described later, the frame member may be configured to have following characteristics. In this form, there are four levels of the shelf portion 13, and the four levels of the shelf portion 13 include, from the bottom, a first shelf portion 13A, a second shelf portion 13B, a third shelf portion 13C, and a fourth shelf portion 13D.

The number of the shelf portions 13, that is, the number of the levels is not particularly limited, but is preferably four or more, more preferably a multiple of four. This is because, as will be described later, in this form, the high-pressure tank is arranged such that the orientation thereof deviates by 90° in each level, and the orientation is 270° in the fourth level.

Arrangement of High-Pressure Tank 20

Fixing High-Pressure Tank

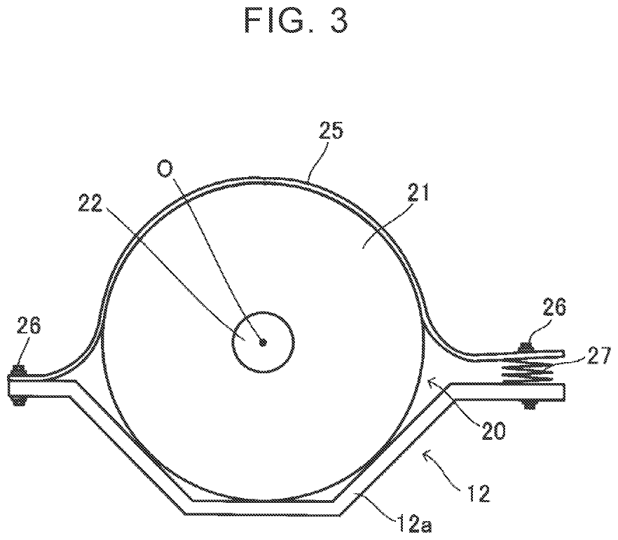

As described above, the high-pressure tanks 20 are arranged on the shelf portion 13 in each level of the gas cylinder bundle frame 11. In this form, each high-pressure tank 20 is fixed to the frame member 12 by the band 25. FIG. 3 is a diagram illustrating that the high-pressure tank 20 is fixed to the frame member 12 by the band 25, and the axial direction O of the high-pressure tank is the further side/nearer side for a viewer.

The band 25 is a strip-shaped member, and is arranged along the outer circumference of the high-pressure tank 20 so as to sandwich the high-pressure tank 20 between the frame member 12 and the band 25. One end and the other end of the band 25 are connected to the frame member 12 by connecting members 26 (for example, bolts and nuts). In this form, one of the connecting members 26 is provided with an elastic body 27 (for example, a spring) so that the tightening force of the band 25 to the high-pressure tank 20 is adjusted when the diameter of the high-pressure tank 20 becomes smaller as the medium is consumed. In addition, as shown in FIG. 3, the frame member 12 may be provided with a recess 12a at a position where the high-pressure tank 20 is arranged. Thereby, the stability of holding the high-pressure tank 20 can be enhanced.

Although the material for forming the band is not particularly limited, it is preferably a material that is advantageous in terms of the strength and the elastic deformation. From this viewpoint, it is preferably a metal, and examples thereof can include stainless steel. Although the thickness of the material is not limited, in the case of the stainless steel, the thickness thereof can be about 0.5 mm to 2 mm.

Two such bands 25 are preferably arranged for one high-pressure tank 20.

Arrangement of High-Pressure Tank on Shelf Portion of Each Level

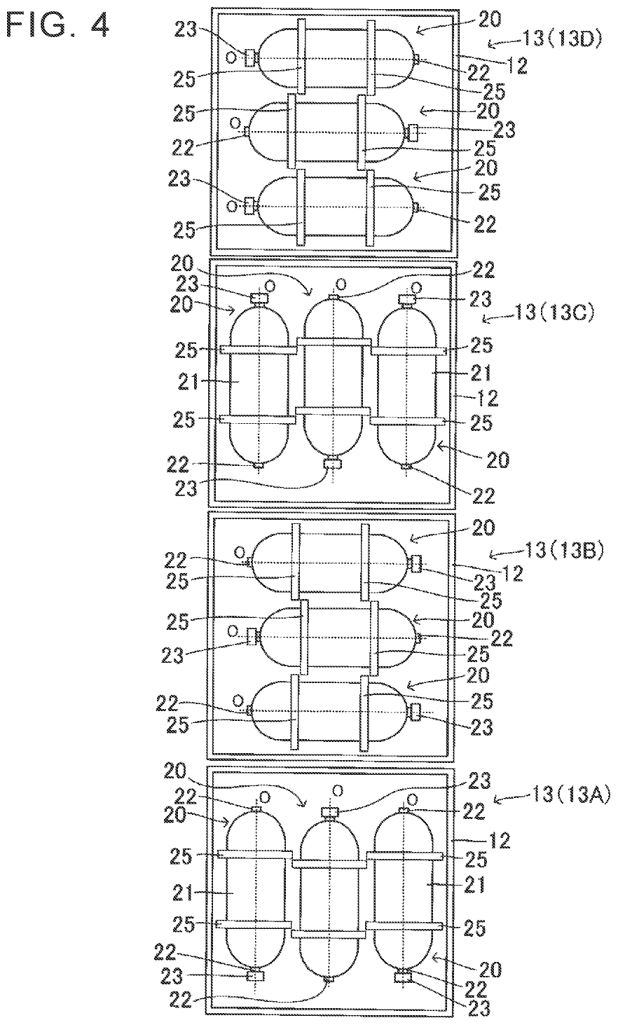

FIG. 4 shows the orientation of the high-pressure tank 20 on each shelf portion 13A to 13D of each level. FIG. 4 shows the first shelf portion 13A, the second shelf portion 13B, the third shelf portion 13C, and the fourth shelf portion 13D from the bottom of the drawing sheet, and is a view of each shelf portion 13A to 13D seen from the direction shown by arrow B in FIG. 1A.

The number of the high-pressure tanks 20 arranged on each shelf portion 13 of the gas cylinder bundle frame 11 is not particularly limited, and one or more of the high-pressure tanks 20 may be arranged. However, from the viewpoint of arranging as many high-pressure tanks 20 as possible on one gas cylinder bundle frame 11, it is preferable to arrange a plurality of the high-pressure tanks 20 on one shelf portion 13. In this form, three high-pressure tanks 20 are arranged on one shelf portion 13 as an example.

In this form, the three high-pressure tanks 20 are arranged on each of the shelf portions 13A to 13D of each level. When the high-pressure tanks 20 are arranged on the shelf portion 13 of each level as described above, the high-pressure tanks 20 are preferably arranged such that the axial direction O of the tank body 21 is the same direction, and the valves 23 of adjacent high-pressure tanks 20 face in opposite directions.

Since the center of gravity of the high-pressure tank 20 deviates from the center of the tank body 21 by the valve 23 as described above, the position of the center of gravity can be brought closer to the center of the level when considering the entire level by arranging the high-pressure tanks 20 such that the valves 23 of the adjacent high-pressure tanks 20 on the shelf portion 13 of the one level face in the opposite directions.

Relationship of Arrangement of High-Pressure Tanks in Adjacent Levels

In this form, the axial direction O of the high-pressure tank 20 arranged on the shelf portion 13 of one level and the axial direction O of the high-pressure tank 20 arranged on the shelf portion 13 of a next level above the shelf portion 13 of the one level are arranged so as to deviate by 90° in a plan view (viewpoint from the direction indicated by arrow B in FIG. 1A). As a result, the center of gravity balance of the gas cylinder bundle 10 as a whole is adjusted, and the strength of the gas cylinder bundle 10 can be increased. That is, when the structure of the gas cylinder bundle frame 11 is the same, many high-pressure tanks 20 can be arranged, and when the same number of the high-pressure tanks 20 is arranged, the weight of the gas cylinder bundle frame 11 can be reduced.

Taking this form as an example, the high-pressure tank 20 is arranged such that the axial direction O of the high-pressure tank 20 arranged on the second shelf portion 13B faces so as to deviate by 90° in the counterclockwise direction from the axial direction O of the high pressure tank 20 arranged on the first shelf portion 13A. The high-pressure tank 20 is arranged such that the axial direction O of the high-pressure tank 20 arranged on the third shelf portion 13C faces so as to deviate by 90° in the counterclockwise direction from the axial direction O of the high pressure tank 20 arranged on the second shelf portion 13B. The high-pressure tank 20 is arranged such that the axial direction O of the high-pressure tank 20 arranged on the fourth shelf portion 13D faces so as to deviate by 90° in the counterclockwise direction from the axial direction O of the high pressure tank 20 arranged on the third shelf portion 13C. The gas cylinder bundle frame 11 is constructed such that the axial direction O of the high-pressure tank 20 deviates by 90° in the counterclockwise direction in each level as the level is high when viewed from the first shelf portion 13A.

Considering that the axial direction O is deviated by 90° in each level as described above, the number of the shelf portions 13 (the number of levels) is preferably a multiple of four. As a result, a stable structure that is less likely to vibrate is obtained, and the above effects become more remarkable.

Here, when five or more shelf portions 13 are provided, the fifth to eighth levels deviate in the opposite direction from the first to fourth levels. It is preferable that the ninth to twelfth levels deviate in the opposite direction from the fifth to eighth levels. In this example, each of the first to fourth shelf portions deviates by 90° in the counterclockwise direction. Therefore, the high-pressure tank 20 is preferably arranged such that each of the fifth to eighth shelf portions deviates by 90° in the clockwise direction when the fifth to eighth shelf portions are formed, and each of the ninth to twelfth shelf portions deviates by 90° in the counterclockwise direction when the ninth to twelfth shelf portions are formed. It is preferable to determine the direction in which the axis is deviated in a similar cycle for the thirteenth and subsequent levels.

As a result, a stable structure that is less likely to vibrate is obtained, and the above effects become more remarkable.

Other

Arrangement of Regulator

In the gas cylinder bundle, pipes drawn from the high-pressure tanks included in the gas cylinder bundle are merged, and the pressure of the storage medium flowing through the gas cylinder bundle is adjusted by a regulator and supplied to the outside. In this form, the regulator may be arranged on the uppermost shelf portion 13.

Arranging the regulator on the uppermost shelf portion 13 makes it easier to manufacture a gas cylinder bundle with different numbers of levels. That is, with the uppermost shelf portion 13 as a reference, a level may be added to a lower level than the uppermost shelf portion. In conventional gas cylinder bundles, the vibration and deformation due to the center of gravity are not taken into account as in the present disclosure, so that the vibration and deformation tend to increase as the number of levels is increased. Therefore, it was necessary to increase the strength of the gas cylinder bundle frame on the lower side (for example, increase the thickness of the frame material), etc. On the other hand, in this form, even when the number of levels is increased, the structure is stable, so that common design can be used regardless of the number of levels. Therefore, designing and manufacturing are easy.

Suspension Member

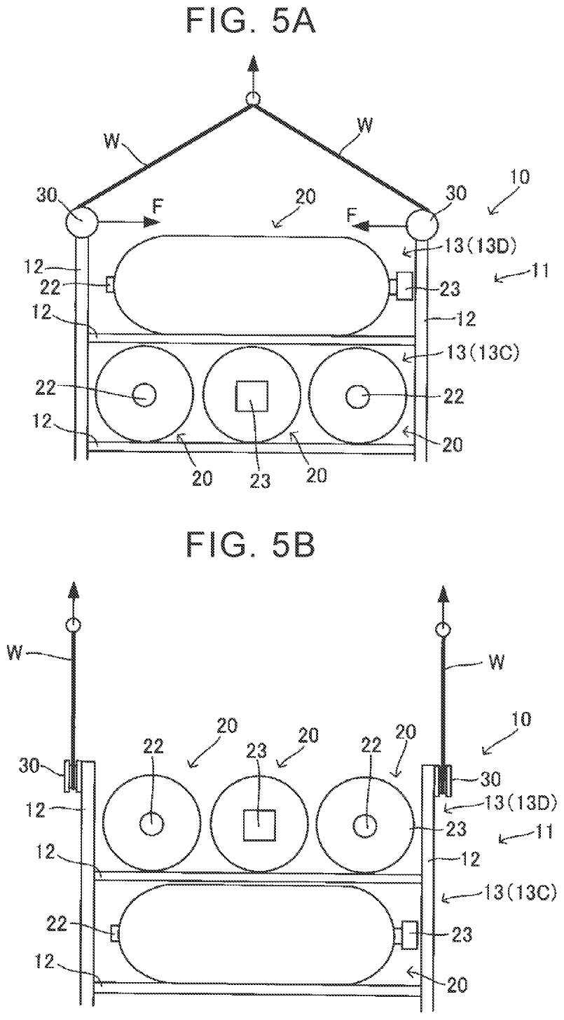

FIGS. 5A and 5B show the gas cylinder bundle 10 equipped with a suspension member 30. FIG. 5A is a view focusing on the upper portion of the gas cylinder bundle 10 from the same viewpoint as FIG. 1A, and FIG. 5B is a view focusing on the upper portion of the gas cylinder bundle 10 from the same viewpoint as FIG. 1B.

As can be seen from FIGS. 5A and 5B, the suspension member 30 is a member arranged at the uppermost shelf portion 13, and is a member having a cylindrical shape where a suspension wire W is hooked on the side surface thereof as shown in FIGS. 5A and 5B. Here, in the suspension member 30 according to this form, an elastic body is arranged at a portion where the wire W is hooked. As a result, it is possible to absorb and mitigate the inwardly acting force F and vibration generated when the gas cylinder bundle 10 is lifted by the suspension wire W, as shown in FIG. 5A. Such force F acts in the direction of compression applied to the uppermost shelf portion 13 and causes the deformation of the gas cylinder bundle. Although the vibration may also cause the deformation, the suspension member 30 can suppress the deformation.

An applicable elastic body is not particularly limited, but examples thereof include natural rubber, nitrile-butadiene rubber, and ethylene-propylene rubber.

Connection of Upper and Lower Bands

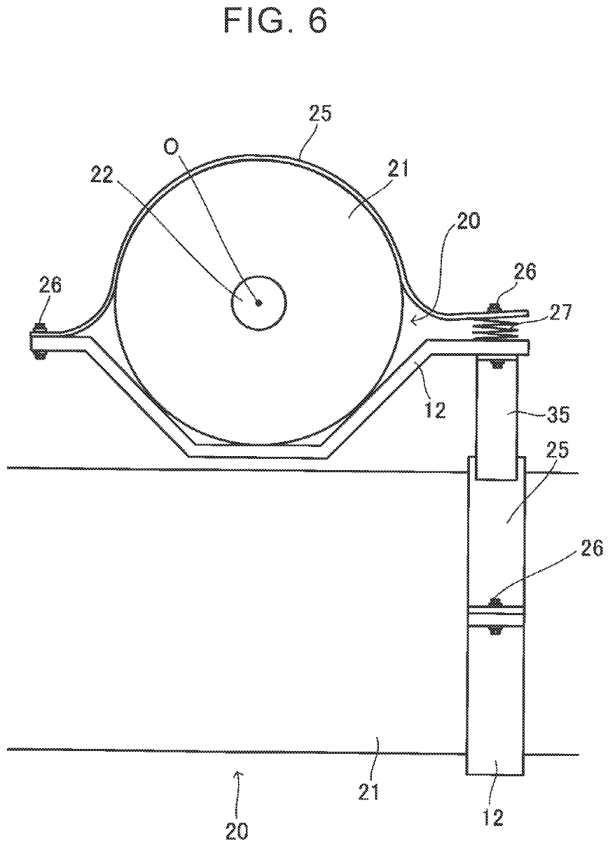

FIG. 6 shows a diagram illustrating an example in which a connector 35 is provided. FIG. 6 is a diagram focusing on a portion of one high-pressure tank 20 and a part of another high-pressure tank 20 arranged in the lower level where the band 25 is arranged. The connector 35 is a metal fitting extending in the up-down direction, the lower end thereof is connected to the band 25 arranged in the lower level, and the upper end thereof is connected to the band 25 arranged in the upper level. Thereby, the upper and lower bands 25 are connected to each other to further increase the strength. At this time, it is preferable that the upper end of the connector 35 is connected to the side of the band 25 arranged in the upper level on which the elastic body 27 is arranged. According to this, it is possible to minimize the amount of the clearance to be provided in consideration of the diameter change of the high-pressure tank, and to reduce the distance between the upper and lower sides of the high-pressure tank 20.

What is claimed is:

1. A gas cylinder bundle including a gas cylinder bundle frame and a high-pressure tank arranged on the gas cylinder bundle frame, wherein:
the gas cylinder bundle frame is equipped with a plurality of levels of shelf portions in an up-down direction on which the high-pressure tank is arranged; and
the high-pressure tank is arranged such that an axial direction of the high-pressure tank arranged on a shelf portion of a next level above a shelf portion of one level faces a direction rotated by 90° with respect to an axial direction of the high-pressure tank arranged on the shelf portion of the one level.

2. The gas cylinder bundle according to claim 1, wherein the number of a plurality of the levels is a multiple of four.

3. The gas cylinder bundle according to claim 1, wherein when the number of the levels is five or more, the direction rotated by 90° is opposite for each level in which the number of the shelf portions is a multiple of four.

4. The gas cylinder bundle according to claim 1, wherein a plurality of the high-pressure tanks is arranged on the shelf portion of the one level, and a direction in which valves are arranged in adjacent high-pressure tanks is opposite.

5. The gas cylinder bundle according to claim 1, wherein a regulator is arranged in an uppermost level among the levels.

6. The gas cylinder bundle according to claim 1, wherein a suspension member for hooking a suspension wire is arranged on an upper portion, and an elastic body is arranged in a portion of the suspension member for hooking the wire.

7. The gas cylinder bundle according to claim 1, wherein the high-pressure tank is fixed to the gas cylinder bundle frame by a band, and the band is connected at adjacent upper and lower levels.

8. The gas cylinder bundle according to claim 7, wherein one end of the band is fixed to the gas cylinder bundle frame via an elastic body, and for connection of the band at the adjacent upper and lower levels, a side where the elastic body is arranged is fixed.
